(19) United States
(12) Patent Application Publication
(10) Pub. No.: US 2026/0299352 A1
(43) Pub. Date: Oct. 1, 2026

(54) DISPLAY DEVICE

(71) Applicant: Shanghai Tianma Micro-Electronics Co., Ltd., Shanghai (CN)

(72) Inventor: Yuki ITO, Kawasaki (JP)

(73) Assignee: Shanghai Tianma Micro-Electronics Co., Ltd., Shanghai (CN)

(21) Appl. No.: 19/570,317

(22) Filed: Mar. 18, 2026

(30) Foreign Application Priority Data
Mar. 25, 2025 (JP) 2025-049506
Dec. 3, 2025 (JP) 2025-226631

(51) Int. Cl. G02F 1/1335; G02F 1/1333; G02F 1/13357

(52) U.S. Cl. CPC G02F 1/133531; G02F 1/13338; G02F 1/133562; G02F 1/133615; G02F 2203/11

(57) ABSTRACT

The present disclosure provides a display device. The display device includes a display panel, an infrared camera, an infrared light source, a first imaging polarizing plate, and a second imaging polarizing plate. The infrared camera is arranged on a rear surface side that is an opposite side to a display surface of the display panel. The first imaging polarizing plate is arranged at a first position matching a main surface side of the display panel and has a first polarization characteristic for infrared light. The second imaging polarizing plate is arranged at a second position on an output side of the infrared light source and has a second polarization characteristic that is different from the first polarization characteristic for infrared light.

### CROSS-REFERENCE TO RELATED APPLICATIONS

This application claims the benefit of Japanese Patent Application No. 2025-049506, filed on Mar. 25, 2025, and Japanese Patent Application No. 2025-226631, filed on Dec. 3, 2025, of which the entirety of the disclosure is incorporated by reference herein.

### FIELD OF THE INVENTION

This application relates to a display device.

### BACKGROUND OF THE INVENTION

Unexamined Japanese Patent Application Publication No. 2022-123858 discloses an eye-tracking technology using an electrically controllable polarized light system. The polarized light system described in Unexamined Japanese Patent Application Publication No. 2022-123858 reduces influence of high glare caused by specular reflection from high-reflectance surfaces like glasses of a subject, and thereby improves quality of an image generated by a camera.

Unexamined Japanese Patent Application Publication (Translation of PCT Application) No. 2023-534071 discloses an electronic device that includes a light source and an optical sensor module arranged on a back surface of a liquid crystal display (LCD) panel and that captures fingerprint information using infrared light.

The technology in Unexamined Japanese Patent Application Publication No. 2022-123858 does not assume that the camera is arranged on the rear surface side of the display device. In a case where an infrared camera that performs imaging using infrared light is installed within a display area, there is a risk that infrared light reflected by glasses or the like prevents the eyes from being detected due to diffraction of the infrared light when the infrared light passes through the display panel. The technology in Unexamined Japanese Patent Application Publication No. 2023-534071 is intended to capture fingerprint information and does not take into consideration influence associated with reflection by glasses and the like.

### SUMMARY OF THE INVENTION

A display device according to the present disclosure includes: a display panel; an infrared camera that is arranged on a rear surface side, the rear surface side being an opposite side to a display surface of the display panel; an infrared light source that outputs infrared light; a first imaging polarizing plate that is arranged at a first position matching a main surface side of the display panel and that has a first polarization characteristic for infrared light; and a second imaging polarizing plate that is arranged at a second position on an output side of the infrared light source and that has a second polarization characteristic, the second polarization characteristic being different from the first polarization characteristic, for infrared light.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a front view illustrating a display device according to Embodiment 1;

FIG. 2 is a cross-sectional view of the display device;

FIG. 3 is a diagram describing an operation example of imaging using infrared light;

FIG. 4A is a cross-sectional view illustrating a configuration example of a lighting unit;

FIG. 4B is a cross-sectional view illustrating a configuration example of a light guide plate;

FIG. 5 is a cross-sectional view illustrating another configuration example according to Embodiment 1;

FIG. 6 is a cross-sectional view illustrating still another configuration example according to Embodiment 1;

FIG. 7 is a cross-sectional view illustrating still another configuration example according to Embodiment 1;

FIG. 8 is a cross-sectional view illustrating a variation of Embodiment 1;

FIG. 9 is a cross-sectional view illustrating another variation of Embodiment 1;

FIG. 10 is a cross-sectional view illustrating still another variation of Embodiment 1;

FIG. 11 is a cross-sectional view illustrating still another variation of Embodiment 1;

FIG. 12 is a cross-sectional view of a display device according to Embodiment 2;

FIG. 13 is a cross-sectional view illustrating another configuration example according to Embodiment 2;

FIG. 14 is a cross-sectional view illustrating a variation of Embodiment 2;

FIG. 15 is a cross-sectional view illustrating a variation in which a first light guide plate and a second light guide plate are applied;

FIG. 16 is a cross-sectional view illustrating a variation in which an LED substrate and a diffusion plate are applied;

FIG. 17 is a cross-sectional view illustrating a variation in which a reflecting layer is applied; and

FIG. 18 is a cross-sectional view illustrating a variation in which a third infrared light polarizing plate is arranged.

### DETAILED DESCRIPTION OF THE INVENTION

The present disclosure is described below in detail, based on the drawings. Note that in the following description, terms indicating specific directions or positions are used as needed. Such terms are, for example, “right”, “left”, “up”, “down”, “front”, “rear”, and other terms that have similar meanings to the forgoing. Such terms are used for facilitating understanding of the present disclosure with reference to the drawings, and the technical scope of the present disclosure is not restricted by the meanings of those terms. In addition, parts designated by the same reference sign appearing in a plurality of drawings indicate the same or similar parts or members.

### Embodiment 1

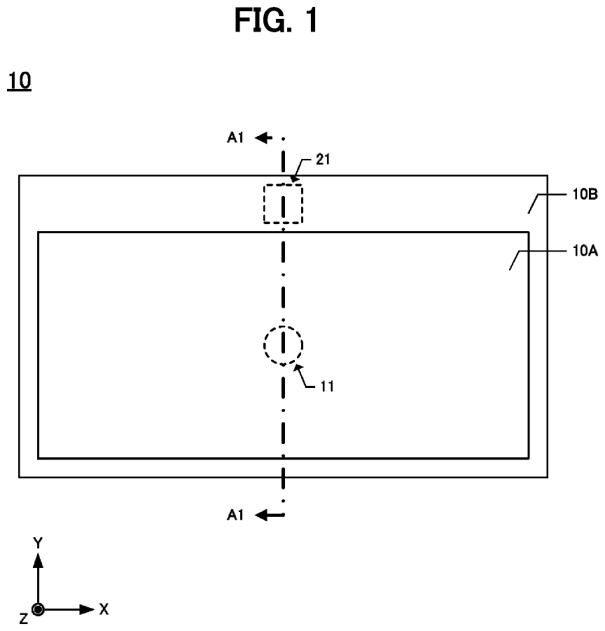

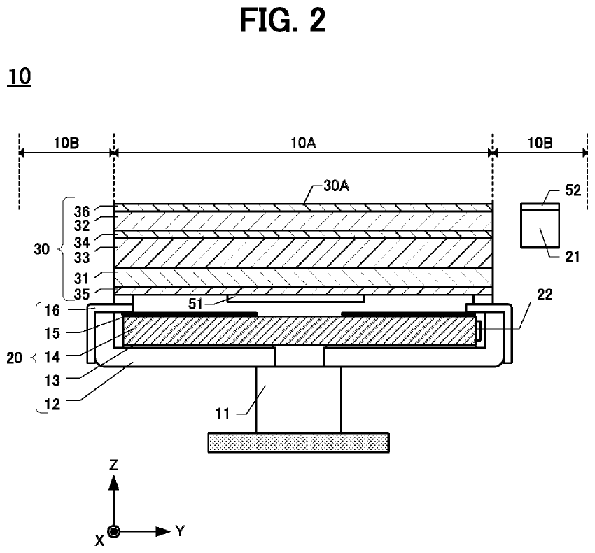

FIG. 1 is a front view illustrating a display device 10 according to Embodiment 1. FIG. 2 is a cross-sectional view taken along the line A1-A1 in FIG. 1. FIGS. 1 and 2 include constituent components with different scales, to facilitate understanding. In addition, description of an X-axis, a Y-axis, and a Z-axis is included in FIGS. 1 and 2. For example, it is assumed that when a display surface of the display device 10 illustrated in FIG. 1 is viewed from the front, the right-left direction serving as the horizontal direction is an X-axis direction and a direction from the left-hand side toward the right-hand side is a +X-direction, the up-down direction serving as the vertical direction is a Y-axis direction and a direction from the lower side toward the upper side is a +Y-direction, and the front-rear direction serving as the depth direction is a Z-axis direction and a direction from the rear side toward the near side is a +Z-direction. Note that the near side along the Z-axis direction is also referred to as a front side or a front surface side. The rear side along the Z-axis direction is also referred to as a rear side or a rear surface side. In other drawings, similar illustrations are also sometimes included as appropriate.

The display device 10 has a display area 10A and a non-display area 10B. The display area 10A is an area where an image is displayed using a display panel. The non-display area 10B is an area that is adjacent to the display area 10A and where no image is displayed, such as a peripheral portion of the display area 10A. The display device 10 in FIG. 1 includes an infrared camera 11 that is arranged on the rear surface side within the display area 10A and an infrared light source 21 that is arranged at a predetermined position in the non-display area 10B. The infrared light source 21 outputs infrared light to be used for imaging using the infrared camera 11.

As illustrated in FIG. 2, the display device 10 includes, in addition to the infrared camera 11 and the infrared light source 21, a lighting unit 20 that serves as a backlight and a liquid crystal panel 30 as an example of the display panel. The lighting unit 20 outputs visible light to be used for display performed by the liquid crystal panel 30.

The infrared camera 11 is positioned further in the −Z-direction than the lighting unit 20 in FIG. 2 on the rear surface side that is the opposite side to the display surface 30A of the liquid crystal panel 30, and is arranged at a rearmost position on the −Z-direction side in the display device 10. The infrared camera 11 is an imaging device capable of generating a camera image by sensing infrared light. For example, the infrared camera 11 is only required to be an infrared camera that uses electromagnetic waves with a wavelength within a range of 800 nm or more and 1500 nm or less as infrared light for imaging. Alternatively, the infrared camera 11 is only required to be a sensor sensing infrared light with a wavelength of 780 nm or more and be particularly capable of performing imaging using near-infrared light with a wavelength of 780 nm to 2500 nm. The infrared light sensed by the infrared camera 11 is output from the infrared light source 21, is reflected by an object to be imaged (not illustrated), passes through the liquid crystal panel 30 and the lighting unit 20 of the display device 10, and is subsequently incident on a lens unit and imaging elements of the infrared camera 11.

The lighting unit 20 in FIG. 2 includes a rear chassis 12, a reflection sheet 13, a light guide plate 14, an optical sheet 15, and a front chassis 16. In the lighting unit 20, the rear chassis 12, the reflection sheet 13, the light guide plate 14, the optical sheet 15, and the front chassis 16 are arranged in this order from the rear side in the −Z-direction toward the front side in the +Z-direction. The lighting unit 20 constitutes a backlight using an edge light system. The lighting unit 20 is capable of emitting visible light from a light emitting surface in the +Z-direction serving as a first direction. For example, light with a wavelength of 380 nm or more and 780 nm or less is defined to be visible light.

The liquid crystal panel 30 is positioned further in the +Z-direction that is a direction toward the near side than the lighting unit 20. The liquid crystal panel 30 is a transmission-type display panel that is capable of displaying an image on the display surface 30A, using visible light from the lighting unit 20. For the liquid crystal panel 30, for example, an active matrix system using thin film transistors (TFTs) can be used. The liquid crystal panel 30 in FIG. 2 includes a TFT substrate 31, a counter substrate 32, a liquid crystal layer 33, a color filter 34, a first visible light polarizing plate 35, and a second visible light polarizing plate 36. The color filter 34 is provided on a surface on the liquid crystal layer 33 side of the counter substrate 32 in conjunction with a light blocking layer (black matrix).

On a passing path of infrared light that is input to the infrared camera 11, a first infrared light polarizing plate 51 serving as a first imaging polarizing plate is arranged. The first infrared light polarizing plate 51 is arranged at a first position within a range from the display surface 30A of the liquid crystal panel 30 to a lens surface of the infrared camera 11. The first infrared light polarizing plate 51 in FIG. 2 is arranged on the −Z-direction side that is the rear surface side of the liquid crystal panel 30. In this case, the first infrared light polarizing plate 51 is stuck on the rear surface of the liquid crystal panel 30 serving as an example of the display panel, on the light emitting surface side of the lighting unit 20 acting as a backlight. It is preferable that the first infrared light polarizing plate 51 in FIG. 2 be arranged at a position matching a field of view (FOV) of the infrared camera 11 and have a size matching the FOV of the infrared camera 11. The FOV is an imaging range of a camera and is also referred to as a viewing angle or a field angle. The first infrared light polarizing plate 51 may have a size larger than the FOV of the infrared camera 11.

On a passing path of infrared light that is output from the infrared light source 21, a second infrared light polarizing plate 52 serving as a second imaging polarizing plate is arranged. The second infrared light polarizing plate 52 is arranged at a second position on an output side of the infrared light source 21. The second infrared light polarizing plate 52 in FIG. 2 is arranged on the +Z-direction side that is the front side of the infrared light source 21. It is preferable that the second infrared light polarizing plate 52 be arranged at a position matching a range of output of infrared light by the infrared light source 21 and have a size matching the range of output of the infrared light by the infrared light source 21. The second infrared light polarizing plate 52 may have a size larger than the range of output of the infrared light by the infrared light source 21.

The first infrared light polarizing plate 51 and the second infrared light polarizing plate 52 are preferably polarizing plates the polarization axes of which are set to be substantially orthogonal to each other as between an s-polarizer and a p-polarizer. Alternatively, the first infrared light polarizing plate 51 may polarize infrared light in a first direction, and the second infrared light polarizing plate 52 may polarize infrared light in an arbitrary second direction different from the first direction. The first infrared light polarizing plate 51 and the second infrared light polarizing plate 52 are only required to be polarizing plates where the polarization axes of the polarization plates being set to polarization directions different from each other allows infrared light the polarization direction of which is the second direction matching the second infrared light polarizing plate 52 to be removed by the first infrared light polarizing plate 51. The first infrared light polarizing plate 51 and the second infrared light polarizing plate 52 are not limited to a linearly polarizing plate, and may be, for example, a circularly polarizing plate or an elliptically polarizing plate. As described above, the first infrared light polarizing plate 51 has a first polarization characteristic for infrared light, and the second infrared light polarizing plate 52 has a second polarization characteristic that is different from the first polarization characteristic for infrared light.

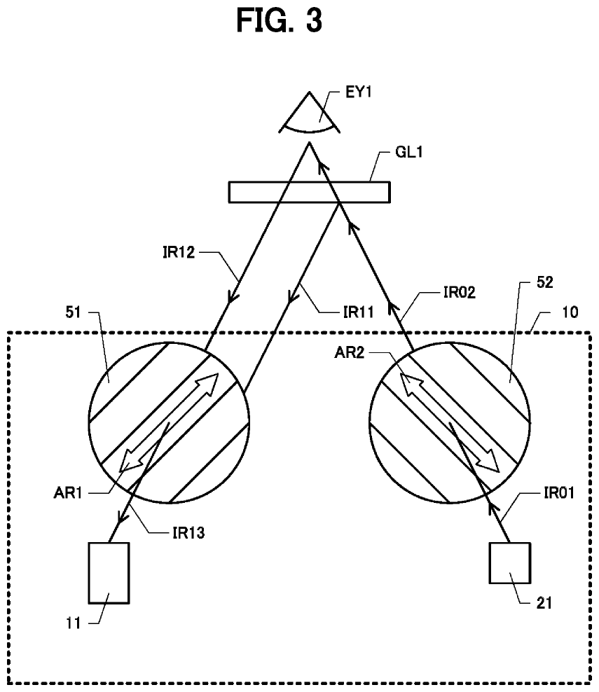

Next, with reference to FIG. 3, an operation example of imaging using infrared light in the display device 10 according to the present embodiment is described below. In the display device 10, the infrared light source 21 outputs infrared light. The second infrared light polarizing plate 52 polarizes the infrared light output from the infrared light source 21 in the second direction. The infrared light that has passed through the second infrared light polarizing plate 52 is emitted to the outside of the display device 10 and radiated on an object to be imaged, such as a driver of a vehicle. The infrared light reflected by the object to be imaged returns to the display device 10, passes through the liquid crystal panel 30 and the lighting unit 20, and is input into the infrared camera 11. In the passing process, the first infrared light polarizing plate 51 polarizes the infrared light in the first direction. The infrared camera 11 senses the input infrared light and generates a camera image. Such imaging using infrared light is described below more specifically.

The infrared light source 21 in FIG. 3 outputs infrared light IR01. The infrared light IR01 is only required to be infrared light including various polarization components, such as non-polarized light and randomly polarized light. The infrared light IR01 output from the infrared light source 21 is incident on the second infrared light polarizing plate 52. The second infrared light polarizing plate 52 transmits infrared light IR02 the polarization direction of which is the second direction among the infrared light IR01 output from the infrared light source 21. For example, the second direction is only required to be a 45-degree upper left diagonal direction, as an arrow AR2 illustrated in FIG. 3. The infrared light IR02 is obtained by removing a polarization component that has a polarization direction different from the second direction from the infrared light IR01. The infrared light IR02 is emitted from the display device 10 to the outside.

The infrared light IR02 emitted from the display device 10 is radiated to an object to be imaged, such as a driver of a vehicle. When the driver of the vehicle is wearing glasses GL1, a portion of the infrared light IR02 is reflected by the glasses GL1 and turns into infrared light IR11, and the other portion of the infrared light IR02 is transmitted through the glasses GL1. The reflection by the glasses GL1 is significantly influenced by, for example, specular reflection. The specular reflection maintains a polarization state of incident infrared light. In FIG. 3, the polarization direction of the infrared light IR11 reflected by the glasses GL1 is the same second direction as the polarization direction of the infrared light IR02 incident on the glasses GL1.

The portion of the infrared light IR02 transmitted through the glasses GL1 is reflected by an eye EY1 of the driver and turns into infrared light IR12. The reflection by the eye EY1 of the driver has a significant influence from reflection different from the specular reflection, such as diffuse reflection. Due to such reflection, a polarization state of most of the incident infrared light is not maintained. In FIG. 3, the infrared light IR12 reflected by the eye EY1 of the driver contains a lot of polarization components different from the second direction that is the polarization direction of the infrared light IR02 incident on the glasses GL1. For example, the infrared light IR12 may be non-polarized light, or may contain a specific polarization component more than other polarization components.

The infrared light IR11 and the infrared light IR12 reflected by the object to be imaged return to the display device 10 and are incident on the first infrared light polarizing plate 51. The first infrared light polarizing plate 51 transmits infrared light the polarization direction of which is the first direction among the infrared light IR11 and the infrared light IR12 returned to the display device 10. For example, the first direction is only required to be a 45-degree upper right diagonal direction, as an arrow AR1 illustrated in FIG. 3. In this case, the first infrared light polarizing plate 51 and the second infrared light polarizing plate 52 have transmission axes set to be orthogonal to each other. Note that the transmission axes do not have to be strictly orthogonal to each other and are only required to be substantially orthogonal to each other in such a way as to serves as an example of polarization directions different from each other. The first infrared light polarizing plate 51 is only required to have the polarization direction set to a polarization direction different from the second infrared light polarizing plate 52 in such a way that the infrared light IR11 the polarization direction of which is the second direction can be removed.

Since the polarization direction of the infrared light IR11 is the second direction, the infrared light IR11 is absorbed or reflected by the first infrared light polarizing plate 51 and is removed. The first infrared light polarizing plate 51 transmits infrared light IR13 the polarization direction of which is the first direction among the infrared light IR12. The infrared light IR13 is obtained by removing a polarization component that has a polarization direction different from the first direction from the infrared light IR12. The infrared light IR13 is input to the infrared camera 11. The infrared camera 11 senses the input infrared light IR13 and generates a camera image.

As described above, in the display device 10, the first infrared light polarizing plate 51 and the second infrared light polarizing plate 52 have polarization characteristics different from each other, such as polarization directions different from each other. In a case where the second infrared light polarizing plate 52 polarizes infrared light in the second direction, the first infrared light polarizing plate 51, by polarizing infrared light in the first direction, removes infrared light the polarization direction of which is the second direction. Therefore, since the first infrared light polarizing plate 51 removes infrared light the polarization state of which is maintained due to specular reflection, the first infrared light polarizing plate 51 can reduce influence of glare and achieve suitable imaging. In addition, the first infrared light polarizing plate 51 is stuck on the rear surface of the liquid crystal panel 30 on the light emitting surface side of the lighting unit 20 acting as a backlight. When the first infrared light polarizing plate 51 is arranged on the front surface of the liquid crystal panel 30, there is a possibility that coloring due to influence of the first infrared light polarizing plate 51 occurs on display color of the liquid crystal panel 30. In contrast, the first infrared light polarizing plate 51 being arranged on the rear surface of the liquid crystal panel 30 can reduce occurrence of coloring in display.

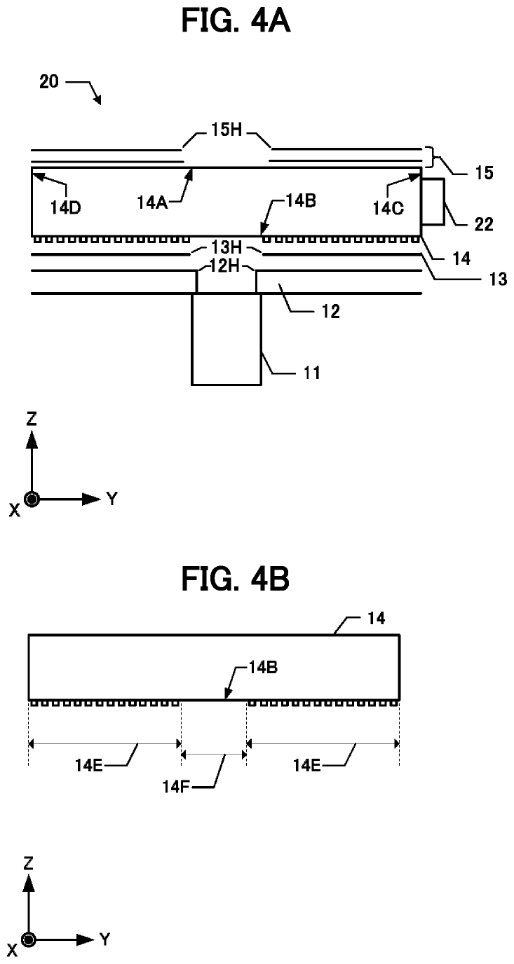

Next, with reference to FIGS. 4A and 4B in conjunction with FIG. 2, a more specific configuration example of the lighting unit 20 is described below. Note that, in order to describe the lighting unit 20, illustration of a portion of the rear chassis 12 and the front chassis 16 is omitted in FIG. 4A. FIG. 4B is a cross-sectional view for a description of the light guide plate 14 in more detail.

The rear chassis 12 serves as a rear support member that houses and supports and fixes the constituent members, in the rear of the lighting unit 20. The rear chassis 12 is only required to be shaped in a box with the front side open and only required to be a rear side member of a housing.

The reflection sheet 13 is a sheet member that is capable of reflecting light that has leaked to the rear side from the light guide plate 14. The reflection sheet 13 may be a specular reflection sheet or a diffuse reflection sheet. The reflection sheet 13 is only required to be able to be configured using, for example, a resin sheet with a high reflectance such as acrylic resin, a metal thin film sheet such as aluminum sheet or stainless steel sheet, a vapor deposition sheet produced by vapor-depositing aluminum, silver, or the like on a resin film, such as a polyester film, serving as a base sheet, a laminated body of a base sheet made of a resin film and a metal thin film, a diffuser produced by adding light-diffusing particles to a base sheet using a transparent material, a white sheet produced by applying white coating on a film surface, or any other material with a high reflectance.

The light guide plate 14 is made of a material with a high transmittance for visible light. The material of which the light guide plate 14 is made is only required to be an acrylic resin such as polymethyl methacrylate (PMMA), a polycarbonate (PC)-based resin, glass, or any other material. The light guide plate 14 is provided with a dot pattern serving as a light distribution control structure with exception of a partial area corresponding to an installation position of the infrared camera 11.

The light guide plate 14 in FIG. 4A has a main surface 14A and a main surface 14B. The main surface 14A is a light emitting surface of the light guide plate 14 and emits visible light in a planar manner on the +Z-direction side that is the front side. The main surface 14B is a light reflecting surface of the light guide plate 14 and reflects visible light on the −Z-direction side that is the rear side. The main surface 14A serves as a first main surface of the light guide plate 14. The main surface 14B serves as a second main surface on the opposite side to the first main surface of the light guide plate 14. The main surface 14A and the main surface 14B are surfaces that face each other.

In addition, the light guide plate 14 has an edge surface 14C and an edge surface 14D. The edge surface 14C is a surface that intersects the main surfaces 14A and 14B on the +Y-direction side. The edge surface 14D is a surface that intersects the main surfaces 14A and 14B on the −Y-direction side. The edge surface 14C and the edge surface 14D are surfaces that face each other.

As illustrated in FIG. 4B, the light guide plate 14 is provided with a dot pattern serving as a light distribution control structure in a first area 14E of the main surface 14B. The first area 14E of the main surface 14B is a light distribution control area that reflects or scatters visible light propagating inside the light guide plate 14 to the main surface 14A side, that is, the +Z-direction side that is the front side. The first area 14E of the main surface 14B is an area remaining after one part corresponding to the installation position of the infrared camera 11 is excepted from the main surface 14B of the light guide plate 14. In other words, the first area 14E of the main surface 14B is an area of the main surface 14B of the light guide plate 14 corresponding to a range where the infrared camera 11 is not installed.

The light guide plate 14 is not provided with a dot pattern in a second area 14F of the main surface 14B. The second area 14F of the main surface 14B is an area in which the portion corresponding to the installation position of the infrared camera 11 is included, on the main surface 14B of the light guide plate 14. In other words, the second area 14F of the main surface 14B is an area corresponding to the range where the infrared camera 11 is installed, on the main surface 14B of the light guide plate 14. The second area 14F of the main surface 14B is an area at a position matching the FOV of the infrared camera 11 and has a size matching the FOV of the infrared camera 11. As described above, the light guide plate 14 is provided with a dot pattern serving as the light distribution control structure in the first area 14E that is a remaining area with the exception of the second area 14F as one partial area of the main surface 14B.

In the +Y-direction of the light guide plate 14 in FIG. 4A, a light source unit 22 is arranged. The light source unit 22 is a linear light source with a plurality of light emitting elements arranged in a line along the X-axis direction, adjacent to the edge surface 14C of the light guide plate 14. In the light source unit 22, the plurality of light emitting elements is arranged in such a manner that light emitting surfaces face the edge surface 14C of the light guide plate 14. Each of the light emitting elements included in the light source unit 22 is only required to be, for example, a light emitting diode (LED), or any other component capable of emitting visible light may be applied to the light emitting element. In the light source unit 22, visible light emitted from each light emitting element in the −Y-direction is incident on the edge surface 14C toward the inside of the light guide plate 14. As described above, the light source unit 22 is a visible light source that emits visible light to be incident on the edge surface 14C of the light guide plate 14. In FIG. 4A, a side surface reflection tape may be stuck on the edge surface 14D on the opposite side to the edge surface 14C of the light guide plate 14. Note that, on the edge surface 14D, another light source unit 22 may be arranged, as with the edge surface 14C.

The optical sheet 15 is a sheet member to adjust visible light emitted from the light guide plate 14 to the front side. The optical sheet 15 is only required to be able to be configured including all or some of a diffusion sheet, a lens sheet, a polarization control sheet, and a louver sheet. The diffusion sheet diffuses the visible light emitted from the light guide plate 14. The lens sheet adjusts a light distribution direction of the visible light emitted from the light guide plate 14. The polarization control sheet improves brightness of the visible light emitted from the light guide plate 14 and transmits specific polarized light, using, for example, a brightness enhancement film (BEF) or a dual brightness enhancement film (DBEF) (registered trademark). The louver sheet removes an unnecessary component of the visible light emitted from the light guide plate 14.

In the light guide plate 14, the dot pattern may be one of protruding portions, recessed portions, steps, protrusions, white paints, and metal thin films, combinations of all or some of the foregoing, or other minute reflecting parts made of an arbitrary structure or member capable of reflecting visible light. The dot pattern is only required to be able to be made by, for example, printing such as inkjet printing, photolithography, etching, laser processing, blasting, or any other physical or chemical manufacturing method. The dot patterns may be made inside the light guide plate 14, or may be added to the outside of the light guide plate 14.

The dot pattern provided in the first area 14E on the main surface 14B of the light guide plate 14 may have, for example, a pattern occupancy rate of approximately 20 to 80%. The pattern occupancy rate is a ratio of total area of an area used for shaping the dot pattern per unit area. The pattern occupancy rate of the dot pattern is only required to correspond to size and the number or density of dots of the dot pattern.

The dot pattern provided in the first area 14E on the main surface 14B of the first light guide plate 14 is only required to have a distribution in which the pattern occupancy rate is uniform or varies in such a way that brightness of visible light emitted from the main surface 14A to the +Z-direction side that is the front side has a uniform or arbitrary distribution.

The dot pattern provided in the first area 14E of the light guide plate 14 can be adjusted with respect to an arbitrary characteristic, such as a shape, size, density, a pattern occupancy rate, and composition materials, and are only required to be able to achieve the brightness uniformity of visible light emitted from the lighting unit 20. The characteristics of the dot pattern provided in the first area 14E of the light guide plate 14 may be adjustable by taking into consideration the arrangement of the plurality of light emitting elements included in the light source unit 22. The dot pattern provided in the first area 14E of the light guide plate 14 preferably has a shape that causes visible light to be reflected or scattered at an angle close to vertical with respect to the light emitting surface of the lighting unit 20.

The front chassis 16 serves as a front support member that clamps and supports and fixes the constituent members in conjunction with the rear chassis 12, in front of the lighting unit 20. The front chassis 16 is only required to have a frame shape with the rear side open and the front side open except for a peripheral portion and only required to be a front side member of the housing.

To allow infrared light input to the infrared camera 11 to pass, the rear chassis 12, the reflection sheet 13, and the optical sheet 15 have a through-hole 12H, a through-hole 13H, and a through-hole 15H, respectively. Each of the through-holes 12H, 13H, and 15H serves as an opening that has a size not blocking the FOV of the infrared camera 11.

In the display area 10A of the display device 10, infrared light incident from the outside in the +Z-direction passes through a transmitting portion of the liquid crystal panel 30. The transmitting portion of the liquid crystal panel 30 is an area that is provided in accordance with a combination of a transparent portion of the TFT substrate 31, the liquid crystal layer 33, and the color filter 34 and the light shielding layer (black matrix) on the counter substrate 32, and that transmits visible light from the lighting unit 20. The infrared light that has passed through the transmitting portion of the liquid crystal panel 30 is polarized by the first infrared light polarizing plate 51. Subsequently, the infrared light passes through the through-hole 15H that serves as an opening provided in the optical sheet 15 of the lighting unit 20 and is incident on the light guide plate 14.

In the light guide plate 14, the infrared light incident from the +Z-direction side that is the front side of the main surface 14A can propagate inside the light guide plate 14 to the −Z-direction side that is the rear side. Subsequently, at least a portion of the infrared light can be transmitted through the second area 14F of the main surface 14B. The infrared light having been transmitted through the second area 14F of the main surface 14B in the light guide plate 14 passes through the through-hole 13H serving as an opening provided in the reflection sheet 13 and the through-hole 12H serving as an opening provided in the rear chassis 12 and be subsequently incident on the infrared camera 11.

The infrared camera 11 is capable of performing imaging, using infrared light that is transmitted through the second area 14F of the main surface 14B in the light guide plate 14. The light guide plate 14 is provided with a dot pattern serving as the light distribution control structure in the first area 14E that is a remaining area with the exception of the second area 14F serving as a partial area of the main surface 14B from the main surface 14B.

The infrared light to be input to the infrared camera 11 is polarized by the first infrared light polarizing plate 51 before being transmitted through the light guide plate 14. In a case where the material used in the light guide plate 14 is acrylic resin, the polarization direction of infrared light is disrupted due to significant influence of birefringence. After the polarization direction of infrared light is disrupted by the light guide plate 14, it becomes difficult to remove infrared light the polarization state of which is maintained by specular reflection, using a polarizing plate.

The display device 10 in the present embodiment has the first infrared light polarizing plate 51 arranged on the rear surface of the liquid crystal panel 30, on the +Z-direction side that is the light emitting surface side of the lighting unit 20. In this arrangement, by polarizing infrared light reflected by the object to be imaged in the first direction before the infrared light is transmitted through the light guide plate 14, the first infrared light polarizing plate 51 removes infrared light polarized in the second direction that is the polarization direction of the second infrared light polarizing plate 52. In the above-described manner, by removing infrared light the polarization state of which is maintained due to specular reflection, the first infrared light polarizing plate 51 can reduce influence of glare.

The infrared camera 11 does not have sensitivity in a visible light region or has a considerably low sensitivity in the visible light region compared with sensitivity in an infrared region. A camera in which the optical sensitivity of visible light is substantially and significantly reduced by providing an optical filter that transmits only infrared light on a surface of a light incident portion may be used as the infrared camera 11. Because of this configuration, the infrared camera 11 of the display device 10 is capable of performing imaging even while the lighting unit 20 is emitting visible light and thereby enables the visibility of a camera image to be secured. In contrast, in a case where imaging using a visible light camera is performed, change in an operation mode in which the lighting unit 20 of the display device 10 is temporarily and partially switched from a turned-on state to a turned-off state becomes necessary. As described above, differing from a case where a visible light camera is used, the lighting unit 20 of the display device 10 enables the infrared camera 11 to perform imaging and generate an appropriate camera image without switching the operation modes corresponding to the turned-on state and the turned-off state. Therefore, the lighting unit 20 included in the display device 10 of the present disclosure does not need a function of switching operation modes and enable a circuit to be simplified, compared with the case where a visible light camera is used.

The first infrared light polarizing plate 51 and the second infrared light polarizing plate 52 have different polarization characteristics with respect to infrared light, such as the transmission axes being set to be substantially orthogonal to each other. The above-described first infrared light polarizing plate 51 and second infrared light polarizing plate 52 do not require electrical control, and enable the circuit to be simplified.

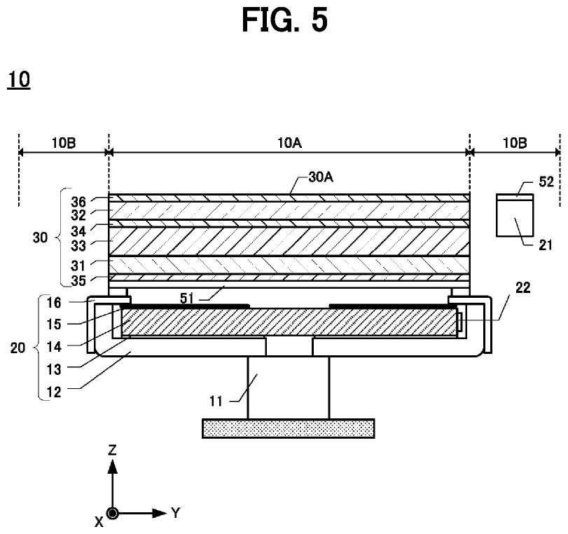

FIG. 5 illustrates another configuration example of the first infrared light polarizing plate 51. In this configuration example, the first infrared light polarizing plate 51 has substantially the same size as the rear surface of the liquid crystal panel 30. The first infrared light polarizing plate 51 in FIG. 5 is arranged in a range corresponding to the entire display area 10A of the display device 10. The first infrared light polarizing plate 51 having a size corresponding to the entire display area 10A of the display device 10 in this way can prevent a boundary portion from being visually recognized by an observer, such as a driver of the vehicle.

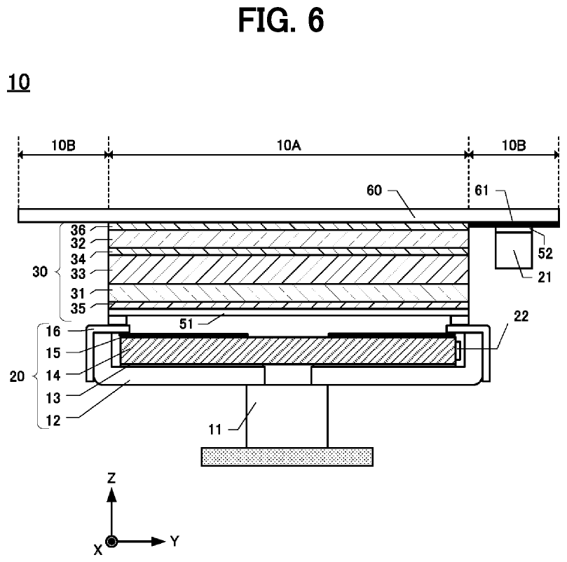

FIG. 6 illustrates another configuration example of the display device 10. In this configuration example, the display device 10 includes a cover glass 60 matching the display area 10A and the non-display area 10B. The cover glass 60 covers the liquid crystal panel 30. In addition, the cover glass 60 covers the infrared light source 21 and the second infrared light polarizing plate 52. The infrared light source 21 and the second infrared light polarizing plate 52 are arranged at a specific position matching the non-display area 10B on the −Z-direction side that is the rear surface side of the cover glass 60. An infrared transmitting paint 61, such as infrared-transmitting black ink, is applied to a surface in the −Z-direction that is the rear surface of the cover glass 60 in accordance with the non-display area 10B of the display device 10. The infrared transmitting paint 61 may be applied in accordance with the whole area of the non-display area 10B, or may be applied in accordance with the specific position at which the infrared light source 21 and the second infrared light polarizing plate 52 are arranged. Using the cover glass 60 to which the infrared transmitting paint 61 is applied in this way can prevent the infrared light source 21 from being visually recognized by an observer, such as a driver of the vehicle. The first infrared light polarizing plate 51 may be arranged between the cover glass 60 and the liquid crystal panel 30.

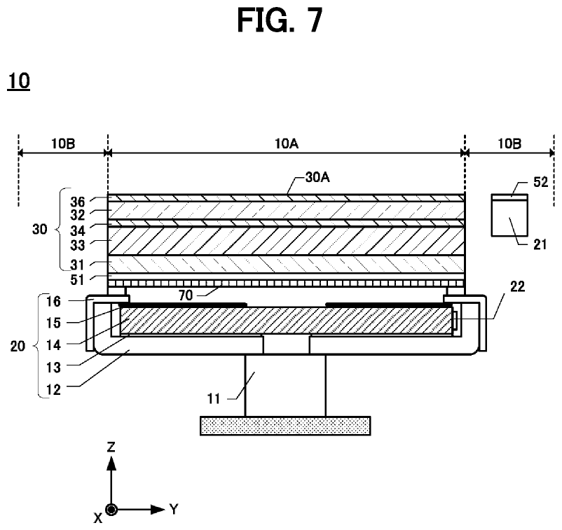

FIG. 7 illustrates still another configuration example of the display device 10. In this configuration example, the display device 10 has the first visible light polarizing plate 35 of the liquid crystal panel 30 removed. In place of the first visible light polarizing plate 35, the first infrared light polarizing plate 51 is arranged between a polarization control sheet 70 and the TFT substrate 31. The polarization control sheet 70 is only required to be, for example, a dual brightness enhancement film (DBEF). In this case, the polarization control sheet 70 and the first infrared light polarizing plate 51 have transmission axes set to be parallel to each other. The polarization control sheet 70 is only required to be a polarization control sheet obtained by rearranging the polarization control sheet included in the optical sheet 15. The first visible light polarizing plate 35 in FIG. 2 is a display polarizing plate that is arranged on the −Z-direction side that is the rear surface side of the liquid crystal panel 30. Removing the first visible light polarizing plate 35 and rearranging the polarization control sheet 70 having been included in the optical sheet 15 as illustrated in FIG. 7 enable the lighting unit 20 to be made thinner and transmittance of both visible light and infrared light to be improved.

In the configurations in FIGS. 6 and 7, the first infrared light polarizing plate 51 has substantially the same size as the rear surface of the liquid crystal panel 30, as with FIG. 5. In contrast, the first infrared light polarizing plate 51 may be arranged at a position matching the FOV of the infrared camera 11 and have a size matching the FOV of the infrared camera 11, as with the configuration in FIG. 2.

### Variations of Embodiment 1

The first infrared light polarizing plate 51 in FIGS. 2 and 5 to 7 is arranged on the −Z-direction side that is the rear surface side of the liquid crystal panel 30. When the liquid crystal panel 30 displays white color, the liquid crystal layer 33 changes the polarization direction of infrared light. Therefore, in the display device 10 in Embodiment 1, an advantageous effect of reducing influence of glare is hindered. As a variation of Embodiment 1, the first infrared light polarizing plate 51 is arranged on the display surface side of the liquid crystal panel 30. The display surface side of the liquid crystal panel 30 is the +Z-direction side that is the front side of the liquid crystal panel 30.

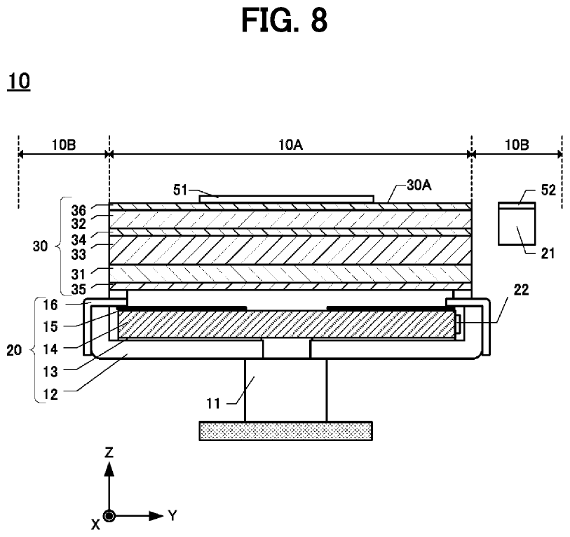

FIG. 8 illustrates a variation corresponding to the display device 10 in FIG. 2. It is preferable that in FIG. 8, the first infrared light polarizing plate 51 be arranged at a position matching the FOV of the infrared camera 11 and have a size matching the FOV of the infrared camera 11, on the +Z-direction side that is the front side of the liquid crystal panel 30. The first infrared light polarizing plate 51 may have a size larger than the FOV of the infrared camera 11. As illustrated in FIG. 8, the first infrared light polarizing plate 51 is arranged on the display surface of the liquid crystal panel 30.

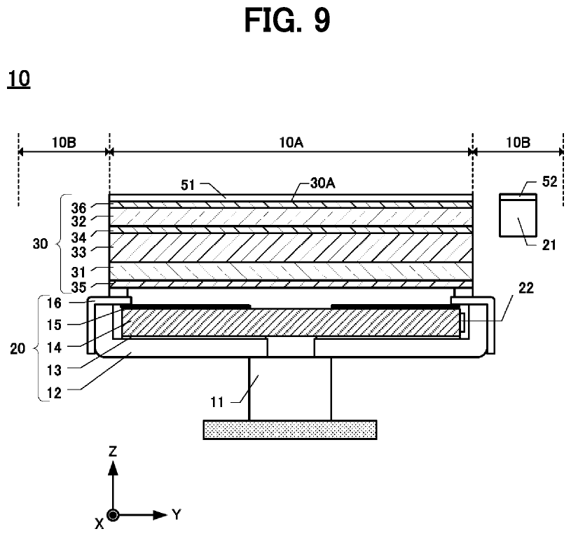

FIG. 9 illustrates a variation corresponding to the display device 10 in FIG. 5. In FIG. 9, the first infrared light polarizing plate 51 has substantially the same size as the front surface of the liquid crystal panel 30 on the +Z-direction side that is the front side of the liquid crystal panel 30. The first infrared light polarizing plate 51 in FIG. 9 is arranged in a range matching the entire display area 10A of the display device 10. Therefore, an observer, such as a driver of the vehicle, cannot visually recognize a boundary portion of the first infrared light polarizing plate 51. As illustrated in FIG. 9, the first infrared light polarizing plate 51 is arranged on the display surface of the liquid crystal panel 30.

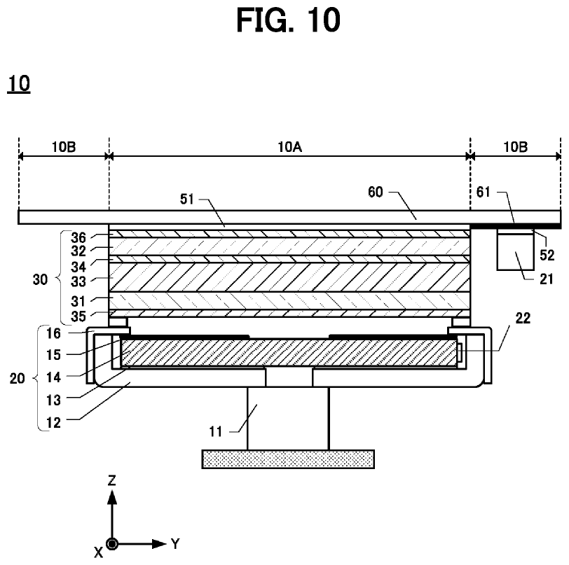

FIG. 10 illustrates a variation corresponding to the display device 10 in FIG. 6. In FIG. 10, the first infrared light polarizing plate 51 has substantially the same size as the front surface of the liquid crystal panel 30, on the +Z-direction side that is the front side of the liquid crystal panel 30. The display device 10 in FIG. 10 includes the cover glass 60 matching the display area 10A and the non-display area 10B. The cover glass 60 in FIG. 10 is only required to be the same as the cover glass 60 in FIG. 6, and the infrared transmitting paint 61 is applied in accordance with the non-display area 10B. Therefore, it is impossible or difficult for an observer, such as a driver of the vehicle, to visually recognize the infrared light source 21. As illustrated in FIG. 10, the first infrared light polarizing plate 51 is arranged on the display surface of the liquid crystal panel 30.

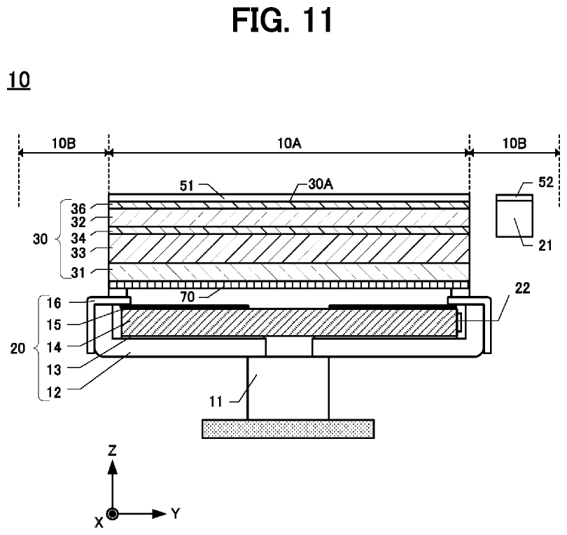

FIG. 11 illustrates a variation corresponding to the display device 10 in FIG. 7. In FIG. 11, the first infrared light polarizing plate 51 has substantially the same size as the front surface of the liquid crystal panel 30, on the +Z-direction side that is the front side of the liquid crystal panel 30. The display device 10 in FIG. 11 includes the polarization control sheet 70 that is the same as the polarization control sheet 70 in FIG. 7 in place of the first visible light polarizing plate 35 of the liquid crystal panel 30. The polarization control sheet 70 and the first infrared light polarizing plate 51 have transmission axes set to be substantially parallel to each other. Because of this configuration, it is possible to make the lighting unit 20 thinner and also improve the transmittance of visible light and infrared light. As illustrated in FIG. 11, the first infrared light polarizing plate 51 is arranged on the display surface of the liquid crystal panel 30.

In the variations in FIGS. 8 to 11, the polarization direction of the first infrared light polarizing plate 51 is set to be substantially parallel to the polarization direction of the second visible light polarizing plate 36 in the liquid crystal panel 30. Other polarization characteristics of the first infrared light polarizing plate 51 are only required to be the same as those in Embodiment 1 described above. The first infrared light polarizing plate 51 may be arranged on the −Z-direction side that is the rear surface side of the second visible light polarizing plate 36 that is included in the liquid crystal panel 30. In particular, in a case whereas illustrated in FIG. 8, the first infrared light polarizing plate 51 has a size smaller than the entire surface of the liquid crystal panel 30, this arrangement of the first infrared light polarizing plate 51 can suppress feeling of disconfort in an external appearance and display. It is preferable that the first infrared light polarizing plate 51 be arranged on the +Z-direction side that is the front side of the liquid crystal layer 33 that is included in the liquid crystal panel 30.

The configuration in Embodiment 1 described afore may be employed in a case where in the liquid crystal panel 30, an area corresponding to the FOV of the infrared camera 11 is displayed in black or not displayed.

The first infrared light polarizing plate 51 is arranged at the first position matching the main surface side of the liquid crystal panel 30, such as the display surface side or the rear surface side of the liquid crystal panel 30. Examples of the first position of the first infrared light polarizing plate 51 may include a position adjacent to a main surface of the liquid crystal panel 30 or a position on the inner side of the main surfaces of the liquid crystal panel 30.

### Embodiment 2

An infrared light source 21 may be arranged on the rear surface side of a liquid crystal panel 30 in conjunction with an infrared camera 11. In this case, the infrared camera 11 is arranged in a first range matching a display area 10A of a display device 10. The infrared light source 21 is arranged in a second range that matches the display area 10A of the display device 10 and that is different from the first range.

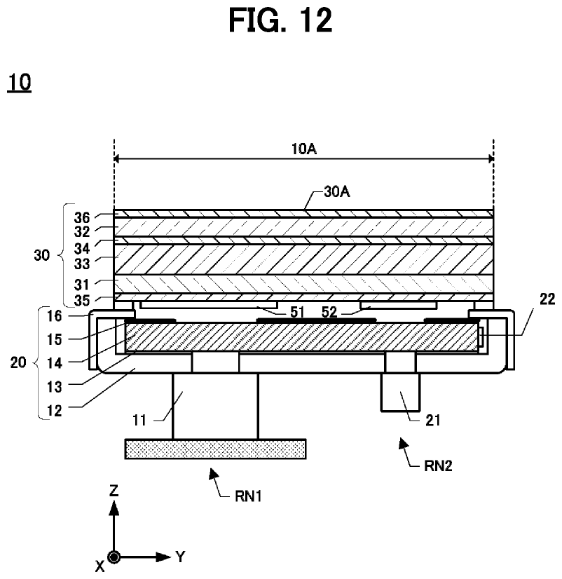

In the display device 10 illustrated in FIG. 12, the infrared camera 11 is arranged in a first range RN1 matching a display surface 30A, on the rear surface side of the liquid crystal panel 30. The infrared light source 21 is arranged in a second range RN2 matching the display surface 30A, on the rear surface side of the liquid crystal panel 30. In accordance with a range of output of infrared light by the infrared light source 21, a rear chassis 12 and a reflection sheet 13 may have through-holes separately from through-holes 12H and 13H, respectively. An optical sheet 15 does not have to have a through-hole that is separate from a through-hole 15H, as long as infrared light output from the infrared light source 21 is able to pass through the optical sheet 15. Alternatively, the optical sheet 15 may have through-holes separately from the through-hole 15H in all or some of sheets in such a way that infrared light output from the infrared light source 21 is facilitated to pass through the optical sheet 15.

In the display device 10 of the present embodiment, a second infrared light polarizing plate 52 is arranged at a second position within a range from the display surface 30A of the liquid crystal panel 30 to an output surface of the infrared light source 21. The second infrared light polarizing plate 52 in FIG. 12 is arranged on the −Z-direction side that is the rear surface side of the liquid crystal panel 30. In this case, the second infrared light polarizing plate 52 is stuck on the rear surface of the liquid crystal panel 30 serving as an example of the display panel, on the light emitting surface side of a lighting unit 20 acting as a backlight. It is preferable that the second infrared light polarizing plate 52 in FIG. 12 be arranged at a position matching a range of output of infrared light by the infrared light source 21 and have a size matching the range of output of the infrared light by the infrared light source 21. The second infrared light polarizing plate 52 may have a size larger than the range of output of the infrared light by the infrared light source 21.

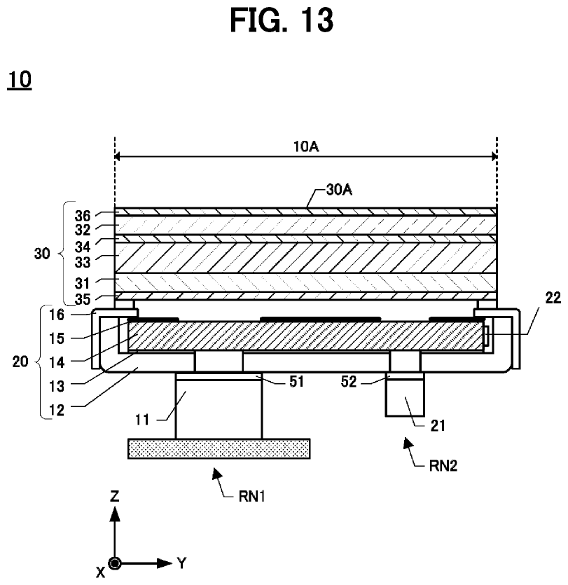

FIG. 13 illustrates another configuration example of the display device 10 of Embodiment 2. In this configuration example, a first infrared light polarizing plate 51 and the second infrared light polarizing plate 52 are arranged on the −Z-direction side that is the rear surface side of a light guide plate 14. The light guide plate 14 is preferably configured using a material of low birefringence, such as synthesized quartz glass and optical transparent resin with low birefringence. In this case, in the light guide plate 14, a polarization direction of infrared light is not disturbed, or there is little disturbance in the polarization direction of infrared light, due to a small influence of birefringence. The polarization state of infrared light transmitted through the light guide plate 14 is substantially maintained. Therefore, the first infrared light polarizing plate 51 in FIG. 13 is capable of removing or reducing infrared light generated by specular reflection.

The first infrared light polarizing plate 51 illustrated in FIG. 13 is arranged close to a lens surface of the infrared camera 11, and the second infrared light polarizing plate 52 is arranged close to an output surface of the infrared light source 21. In place of this configuration, the first infrared light polarizing plate 51 may, for example, be arranged inside the through-hole 12H made in the rear chassis 12. Alternatively, the first infrared light polarizing plate 51 may be arranged between the rear chassis 12 and the reflection sheet 13. Alternatively, the first infrared light polarizing plate 51 may be arranged between the reflection sheet 13 and the light guide plate 14. The second infrared light polarizing plate 52 may, for example, be arranged inside the through-hole made in the rear chassis 12 in accordance with the infrared light source 21. Alternatively, the second infrared light polarizing plate 52 may be arranged between the rear chassis 12 and the reflection sheet 13. Alternatively, the second infrared light polarizing plate 52 may be arranged between the reflection sheet 13 and the light guide plate 14. In the display device 10 of Embodiment 1, in a case where the light guide plate 14 is configured using a low-birefringence material, the first infrared light polarizing plate 51 may be arranged on the −Z-direction side that is the rear surface side of the light guide plate 14. When the display device 10 includes the light guide plate 14 illustrated in FIG. 13, the infrared light source 21 and the second infrared light polarizing plate 52 may be arranged in a non-display area 10B that is located outside the display area 10A, as with the case in FIG. 1.

### Variations of Embodiment 2

In FIGS. 12 and 13, the first infrared light polarizing plate 51 and the second infrared light polarizing plate 52 are arranged on the −Z-direction side that is the rear surface side of the liquid crystal panel 30. As with Embodiment 1, when the liquid crystal panel 30 displays white color, a liquid crystal layer 33 changes the polarization direction of infrared light. Therefore, in the display device 10 in Embodiment 2, an advantageous effect of reducing influence of glare is also hindered. As a variation of Embodiment 2, the first infrared light polarizing plate 51 and the second infrared light polarizing plate 52 are arranged on the display surface side of the liquid crystal panel 30. The display surface side of the liquid crystal panel 30 is the +Z-direction side that is the front side of the liquid crystal panel 30.

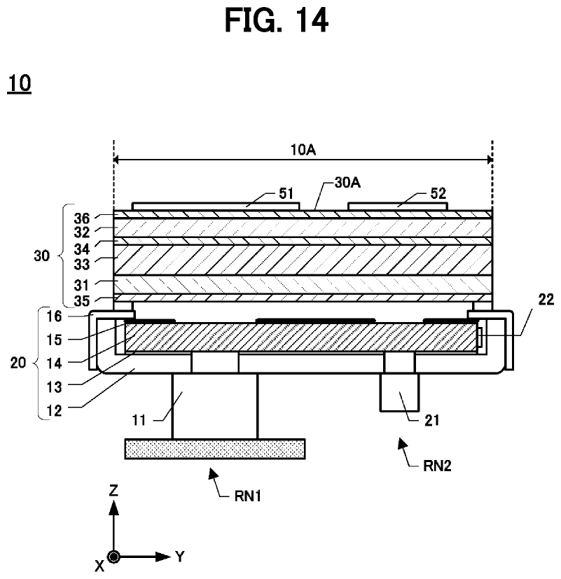

FIG. 14 illustrates a variation corresponding to the display device 10 in FIGS. 12 and 13. It is preferable that in FIG. 14, the first infrared light polarizing plate 51 be arranged at a position matching the FOV of the infrared camera 11 and have a size matching the FOV of the infrared camera 11, on the +Z-direction side that is the front side of the liquid crystal panel 30. The first infrared light polarizing plate 51 may have a size larger than the FOV of the infrared camera 11. It is preferable that the second infrared light polarizing plate 52 in FIG. 14 be arranged at a position matching a range of output of infrared light by the infrared light source 21 and have a size matching the range of output of the infrared light by the infrared light source 21, on the +Z-direction side that is the front side of the liquid crystal panel 30. The second infrared light polarizing plate 52 may have a size larger than the range of output of the infrared light by the infrared light source 21. As illustrated in FIG. 14, the first infrared light polarizing plate 51 and the second infrared light polarizing plate 52 are arranged on the display surface of the liquid crystal panel 30.

The first infrared light polarizing plate 51 and the second infrared light polarizing plate 52 may be arranged on the −Z-direction side that is the rear surface side of the second visible light polarizing plate 36 included in the liquid crystal panel 30. This configuration suppresses feeling of discomfort in an external appearance and display. It is preferable that the first infrared light polarizing plate 51 and the second infrared light polarizing plate 52 be arranged on the +Z-direction side that is the front side of the liquid crystal layer 33 included in the liquid crystal panel 30.

The configuration in Embodiment 2 described afore may be employed in a case where in the liquid crystal panel 30, an area corresponding to the FOV of the infrared camera 11 and an area corresponding to the range of output of infrared light by the infrared light source 21 are displayed in black or not displayed.

The first infrared light polarizing plate 51 is arranged at the first position matching the main surface side of the liquid crystal panel 30, such as the display surface side or the rear surface side of the liquid crystal panel 30. The second infrared light polarizing plate 52 may be arranged at a second position matching the main surface side of the liquid crystal panel 30, such as the display surface side or the rear surface side of the liquid crystal panel 30. Examples of the first position of the first infrared light polarizing plate 51 or the second position of the second infrared light polarizing plate 52 may include a position adjacent to the liquid crystal panel 30 or a position on the inside of the liquid crystal panel 30.

### Other Variations

The light source unit 22 is only required to be a light source unit with the arrangement of which is appropriately adjusted in consideration of brightness uniformity and other visible light output characteristics, the arrangement may include one of the number, positions, directions, ranges of radiation, and amounts of light emission of light emitting elements or a combination of all or some of the foregoing. The position of the infrared camera 11 is only required to be an arbitrarily determined position within a range matching the display area 10A of the display device 10. The position of the infrared light source 21 is only required to be an arbitrarily determined position within a range matching the display area 10A or the non-display area 10B of the display device 10.

The display device 10 may include an optical functional film that is capable of transmitting infrared light and reflecting visible light to prevent the infrared camera 11 from being visually recognized from the outside. The optical functional film as described above is only required to be an optical functional film that has an appropriate arrangement and size within a range from the rear surface of the liquid crystal panel 30 to the infrared camera 11.

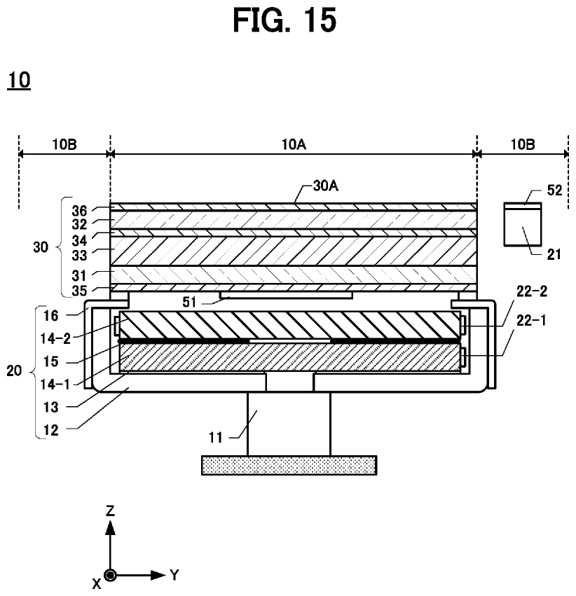

The lighting unit 20 may include a second light guide plate 14-2 in addition to a first light guide plate 14-1 that is similar to the light guide plate 14 in the above-described embodiments. For example, as illustrated in FIG. 15, the first light guide plate 14-1 and the second light guide plate 14-2 that is arranged to overlap the first light guide plate 14-1 in a direction perpendicular to the main surface of the first light guide plate 14-1 may be applied to the lighting unit 20. The second light guide plate 14-2 is stacked over the first light guide plate 14-1 in the Z-axis direction. Note that the optical sheet 15 is stacked while being interposed between the first light guide plate 14-1 and the second light guide plate 14-2.

The second light guide plate 14-2 is made of a material with a high transmittance for visible light, as with the first light guide plate 14-1. The second light guide plate 14-2 is provided with a dot pattern serving as a light distribution control structure in a partial area matching the installation position of the infrared camera 11. The dot pattern provided to the first light guide plate 14-1 is also referred to as a first light distribution control structure, and the dot pattern provided to the second light guide plate 14-2 is also referred to as a second light distribution control structure. The second light guide plate 14-2 is only required to have the same size as that of the first light guide plate 14-1.

The second light guide plate 14-2 has a first main surface on the +Z-direction side that is the front side and a second main surface on the −Z-direction side that is the rear side. The first main surface of the second light guide plate 14-2 is a light emitting surface that emits visible light in a planar manner. The second main surface of the second light guide plate 14-2 is a light reflecting surface that reflects visible light propagating inside the second light guide plate 14-2 and is a light transmitting surface through which visible light from the first light guide plate 14-1 or the optical sheet 15 is transmitted. The second main surface of the second light guide plate 14-2 is a main surface on the opposite side to the first main surface and is a surface facing the first main surface.

The second main surface of the second light guide plate 14-2 includes a first area where no dot pattern is provided and a second area where a dot pattern is provided. In the second light guide plate 14-2, the first area of the second main surface is an area remaining after one part corresponding to the installation position of the infrared camera 11 is excepted from the second main surface. In the second light guide plate 14-2, the second area of the second main surface is an area in which one part corresponding to the installation position of the infrared camera 11 is included, is provided at a position matching the FOV of the infrared camera 11, and has a size matching the FOV of the infrared camera 11. The second light guide plate 14-2 is provided with a dot pattern serving as the second light distribution control structure in the second area that is a partial area on the second main surface.

In the +Y-direction of the first light guide plate 14-1 in FIG. 15, a first light source unit 22-1 is arranged. In the +Y-direction and the −Y-direction of the second light guide plate 14-2, second light source units 22-2 are arranged. Each of the second light source units 22-2 is a linear light source with a plurality of light emitting elements arranged in a line along the X-axis direction, adjacent to an edge surface of the second light guide plate 14-2. In the second light source unit 22-2, the plurality of light emitting elements is arranged with light emitting surfaces facing the edge surface of the second light guide plate 14-2. The plurality of light emitting elements included in the first light source unit 22-1 is also referred to as a plurality of first light emitting elements, and the plurality of light emitting elements included in the second light source units 22-2 is also referred to as a plurality of second light emitting elements. The first light source unit 22-1 is a first light source that emits visible light to be incident on an edge surface of the first light guide plate 14-1. The second light source units 22-2 are second light sources that emit visible light to be incident on edge surfaces of the second light guide plate 14-2. The plurality of second light emitting elements included in the second light source units 22-2 is only required to be controllable to a current value or a luminous flux value that is different from that of the plurality of first light emitting elements included in the first light source unit 22-1 and thereby be able to achieve the brightness uniformity of the visible light emitted from the lighting unit 20.

In the second light guide plate 14-2 illustrated in FIG. 15, visible light reflected or scattered to the +Z-direction side that is the front side by the dot pattern provided in the second area of the second main surface is emitted from the first main surface of the second light guide plate 14-2 to the +Z-direction side that is the front side. Therefore, visible light incident on the edge surfaces into the inside of the second light guide plate 14-2 is emitted from a range of the first main surface corresponding to the area where the dot pattern is provided. In contrast, in the second light guide plate 14-2, a range of the first main surface corresponding to the area where no dot pattern is provided emits visible light that is incident on the second main surface of the second light guide plate 14-2 from the light emitting surface of the first light guide plate 14-1 via the optical sheet 15.

In the second light guide plate 14-2, the range of the first main surface that emits visible light having been incident on the second main surface of the second light guide plate 14-2 from the light emitting surface of the first light guide plate 14-1 is only required to be a first emitting area of the light emitting surface of the lighting unit 20. The range of the first main surface from which visible light having been incident on the edge surfaces into the inside of the second light guide plate 14-2 and reflected or scattered by the dot pattern provided in the second area of the second main surface is emitted is only required to be a second emitting area of the light emitting surface of the lighting unit 20. The above-described first emitting area and second emitting area do not have to be clearly separated ranges. The first emitting area and the second emitting area may include an overlapping range where beams of visible light to be emitted from both areas are mixed. Therefore, the second emitting area of the light emitting surface of the lighting unit 20 is only required to be different from the first emitting area of the light emitting surface at least in part.

In the lighting unit 20 illustrated in FIG. 15, the arrangements of the first light guide plate 14-1 and the second light guide plate 14-2 may be changed. For example, in a case where the optical sheet 15 is arranged on the +Z-direction side that is the frontmost side in the lighting unit 20, the first light guide plate 14-1 may be arranged on the front side of the second light guide plate 14-2, or the second light guide plate 14-2 may be arranged on the front side of the first light guide plate 14-1. Without being limited to the configuration including the second light guide plate 14-2 illustrated in FIG. 15, the configuration of the display device 10 may be, for example, a configuration that does not include the second light guide plate 14-2 in a case where a visible light source can be added to the infrared camera 11 or in a case where display is unnecessary in an area matching a range where the infrared camera 11 is installed.

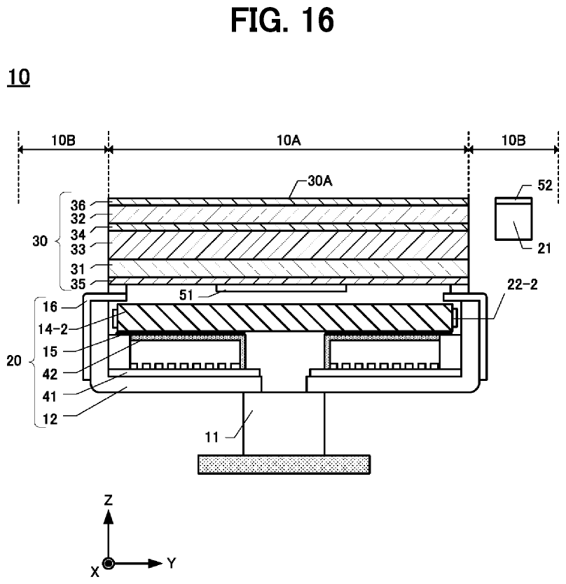

To at least a portion of the lighting unit 20, a direct-type LED backlight module may be applied. For example, as illustrated in FIG. 16, in place of the reflection sheet 13, the first light guide plate 14-1, and the first light source unit 22-1 in FIG. 15, an LED substrate 41 and a diffusion plate 42 may be applied to the lighting unit 20.

The LED substrate 41 is a light emitting element substrate on which a plurality of light emitting elements is arranged. For example, on a substrate surface of the LED substrate 41, a plurality of light emitting elements may be arranged in a matrix or in an arbitrary two-dimensional array that is different from a matrix. In an area where a plurality of light emitting elements is not arranged within the substrate surface of the LED substrate 41 on which the plurality of light emitting elements is installed, a reflection sheet may be stuck separately from the LED substrate 41. In a case where the substrate surface of the LED substrate 41 has a reflection function achieved by white resist, a reflection sheet separate from the LED substrate 41 does not have to be provided. The plurality of light emitting elements arranged on the LED substrate 41 is provided separately from the plurality of light emitting elements included in the second light source units 22-2. The plurality of light emitting elements included in the second light source units 22-2 is only required to be controllable to a current value or a luminous flux value different from that of the plurality of light emitting elements arranged on the LED substrate 41.

The diffusion plate 42 diffuses visible light emitted from the plurality of light emitting elements on the LED substrate 41. A diffuser serving as a diffusion structure is provided on the diffusion plate 42 except a portion matching the installation position of the infrared camera 11. The diffuser is only required to be configurable by adding light diffusing particles to a light guiding material.

The LED substrate 41 and the diffusion plate 42 have through-holes to enable infrared light to be input to the infrared camera 11 to pass through the LED substrate 41 and the diffusion plate 42. Each of the through-holes is an opening that has a size not blocking the FOV area of the infrared camera 11. In accordance with the through-hole of the diffusion plate 42, a side wall body 42A is installed on the −Z-direction side that is the rear surface side of the diffusion plate 42. The side wall body 42A may be configurable using the same diffuser as the diffusion plate 42 or may be configurable using a reflective material different from the diffusion plate 42. The side wall body 42A may have, for example, a cylindrical shape and be integrated with the diffusion plate 42 or may be a separate component from the diffusion plate 42. In the through-hole provided in the diffusion plate 42, a transparent plate made of a material with a high transmittance for infrared light may be installed.

In a case where the LED substrate 41 is used, a local dimming backlight may be configurable. For example, a plurality of light emitting elements arranged on the substrate surface of the LED substrate 41 may have light intensities individually controlled with respect to each of a plurality of divided areas into which the whole arrangement area is divided, each of the light intensities matching a current value or a luminous flux value. The plurality of divided areas is only required to be rectangular areas that do not overlap each other. In each of the divided areas, a current value or a luminous flux value of the light emitting elements, that is, brightness serving as the amount of light emission, may be controlled, in accordance with an input signal indicating information about an image displayed on the liquid crystal panel 30. Without being limited to the configuration including the second light guide plate 14-2 illustrated in FIG. 16, the configuration of the display device 10 may be, for example, a configuration that does not include the second light guide plate 14-2 in a case where a visible light source can be added to the infrared camera 11 or in a case where display is unnecessary in the area matching the range where the infrared camera 11 is installed.

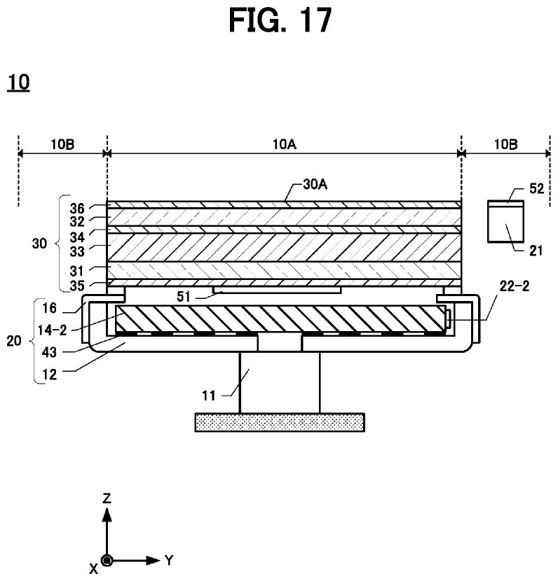

The lighting unit 20 constituting the backlight may have an arbitrary configuration using a single light guide plate corresponding to the second light guide plate 14-2 illustrated in FIG. 15. For example, as illustrated in FIG. 17, in place of the reflection sheet 13, the first light guide plate 14-1, the optical sheet 15, and the first light source unit 22-1 in FIG. 15, a reflecting layer 43 using a plurality of visible light reflectors may be applied to the lighting unit 20. While a second light source unit 22-2 is arranged in the +Y-direction of the second light guide plate 14-2, no second light source unit 22-2 has to be arranged in the −Y-direction of the second light guide plate 14-2.

The reflecting layer 43 is a first light distribution control structure provided in the first area included in the second main surface on the −Z-direction side that is the rear side of the second light guide plate 14-2. A pattern of the reflecting layer 43 including all or some of size, a shape, a number, a distribution, and an occupancy rate in the first area of each visible light reflector in the reflecting layer 43 may be arbitrarily designed, in accordance with output characteristics or the like of visible light output by the lighting unit 20. The occupancy rate in the first area is a ratio of total area of the reflecting layer 43 to total area of the first area. Distribution of the plurality of visible light reflectors in the reflecting layer 43 may be uniform across the first area or may be different in accordance with a position in the first area.

The second area included in the second main surface of the second light guide plate 14-2 may be provided with a light distribution control pattern different from the dot pattern. For example, the light distribution control pattern may be a plurality of grooves each having a shape of a linear notch. A cross section of each groove in the light distribution control pattern has a substantially triangular shape. The light distribution control pattern has a plurality of unit reflectors each of which is arranged on an inner side surface of one of the plurality of grooves. Each unit reflector is only required to be a visible light reflective material applied to or filling the inside of each groove. Size of the light distribution control pattern including pitch is only required to be able to be determined in accordance with all or some of pixel pitch of the liquid crystal panel 30, width of the black matrix, and width of the transmitting portion of the liquid crystal panel 30.

In the above-described variations, the first infrared light polarizing plate 51 may also be arranged on the display surface side of the liquid crystal panel 30. For example, the first infrared light polarizing plate 51 is arranged on the display surface of the liquid crystal panel 30. In other words, the first infrared light polarizing plate 51 is arranged at a first position matching the main surface side of the liquid crystal panel 30, such as the display surface side or the rear surface side of the liquid crystal panel 30. Examples of the first position of the first infrared light polarizing plate 51 may include a position adjacent to a main surface of the liquid crystal panel 30 or a position on the inner side of the main surfaces of the liquid crystal panel 30.

When the liquid crystal panel 30 displays white color, a degree of change by the liquid crystal layer 33 in the polarization direction of infrared light with circular polarization (circularly polarized infrared light) is small. The first infrared light polarizing plate 51 is only required to polarize infrared light in a first rotational direction (for example, a clockwise direction), and the second infrared light polarizing plate 52 is only required to polarize infrared light in the reverse direction to the first rotational direction (for example, a counterclockwise direction). In addition, in a case where the light guide plate 14 is configured using a low-birefringence material, the first infrared light polarizing plate 51 may be arranged on the −Z-direction side that is the rear surface side of the light guide plate 14.

For example, in a case where the lighting unit 20 constitutes a backlight using the edge light system as illustrated in FIGS. 2 and 5 to 7 and the light guide plate 14 is configured using a material with high birefringence, the first infrared light polarizing plate 51 that transmits circularly polarized infrared light may be arranged at a position within a range from the display surface 30A of the liquid crystal panel 30 to the main surface 14A of the light guide plate 14. In addition, in a case where the lighting unit 20 includes the first light guide plate 14-1 and the second light guide plate 14-2 as illustrated in FIG. 15 and both the first light guide plate 14-1 and the second light guide plate 14-2 are configured using a material with high birefringence, the first infrared light polarizing plate 51 may be arranged on the front side of the first light guide plate 14-1 and the second light guide plate 14-2. In a case where the lighting unit 20 constitutes a backlight using the edge light system as illustrated in FIGS. 2 and 5 to 7 and the light guide plate 14 is configured using a material with low birefringence, the first infrared light polarizing plate 51 that transmits circularly polarized infrared light may be arranged at a position within a range from the display surface 30A of the liquid crystal panel 30 to the lens surface of the infrared camera 11. In a case where the lighting unit 20 includes the first light guide plate 14-1 and the second light guide plate 14-2 as illustrated in FIG. 15 and both the first light guide plate 14-1 and the second light guide plate 14-2 are configured using a material with low birefringence, the first infrared light polarizing plate 51 that transmits circularly polarized infrared light can also be arranged at a similar position. In a case where the infrared light source 21 is arranged on the rear surface side of the liquid crystal panel 30 as illustrated in FIGS. 12 and 13, the second infrared light polarizing plate 52 that transmits circularly polarized infrared light may, as with the first infrared light polarizing plate 51, have an arrangement position determined in accordance with the birefringence of the light guide plate 14 and the like.

For example, in a case where the direct-type LED backlight module is applied to the lighting unit 20 as illustrated in FIG. 16 and the second light guide plate 14-2 is configured using a material with high birefringence, the first infrared light polarizing plate 51 that transmits circularly polarized infrared light may be arranged at a position within a range from the display surface 30A of the liquid crystal panel 30 to the first main surface of the second light guide plate 14-2. In a case where the lighting unit 20 does not include the second light guide plate 14-2 or the second light guide plate 14-2 is configured using a material with low birefringence, the first infrared light polarizing plate 51 that transmits circularly polarized infrared light may be arranged at a position within a range from the display surface 30A of the liquid crystal panel 30 to the lens surface of the infrared camera 11.

The first infrared light polarizing plate 51 that transmits circularly polarized infrared light may be arranged either inside the lighting unit 20 or on the lens surface of the infrared camera 11 and may have a minimum required size matching the FOV of the infrared camera 11. Because of this configuration, it is possible to prevent the first infrared light polarizing plate 51 from being visually recognized by an observer and thereby achieve an appropriate display on the liquid crystal panel 30 and reduce a manufacturing cost of the display device 10 at the same time. The second infrared light polarizing plate 52 that transmits circularly polarized infrared light may be arranged either inside the lighting unit 20 or on the output surface of the infrared light source 21 and may have a minimum required size matching the range of output of infrared light by the infrared light source 21. Because of this configuration, it is possible to prevent the second infrared light polarizing plate 52 from being visually recognized by an observer and thereby achieve an appropriate display on the liquid crystal panel 30 and reduce a manufacturing cost of the display device 10 at the same time.

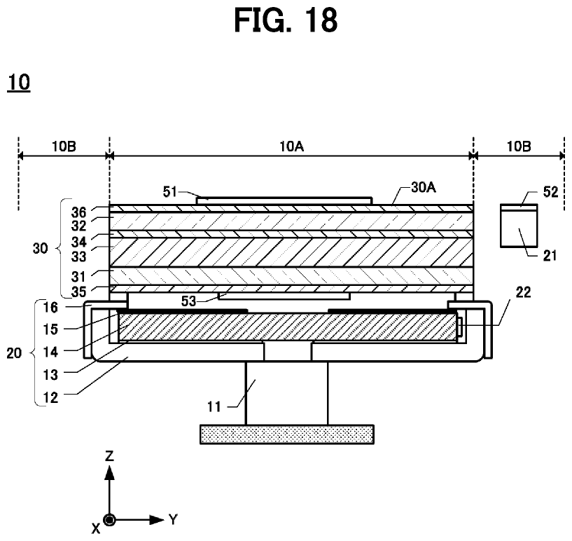

On the display surface 30A and the main surface on the other side of the liquid crystal panel 30, a plurality of infrared light polarizing plates that transmits circularly polarized infrared light may be arranged. For example, FIG. 18 illustrates a display device 10 including the first infrared light polarizing plate 51 and a third infrared light polarizing plate 53 as a mode of embodiment using two circular polarizing plates. In this configuration, the first infrared light polarizing plate 51 is a circularly polarizing plate arranged on the +Z-direction side that is the front side of the liquid crystal panel 30, and the third infrared light polarizing plate 53 is a circularly polarizing plate arranged on the −Z-direction side that is the rear side of the liquid crystal panel 30. The first infrared light polarizing plate 51 and the second visible light polarizing plate 36 are arranged in such a way that the polarization directions are parallel to each other. The third infrared light polarizing plate 53 and the first visible light polarizing plate 35 are arranged in such a way that the polarization directions are parallel to each other. The first infrared light polarizing plate 51 and the second infrared light polarizing plate 52 are arranged in such a way that the polarization directions are substantially orthogonal to each other. The first infrared light polarizing plate 51 and the third infrared light polarizing plate 53 are arranged in such a way that the polarization directions are parallel to each other. Note that the first infrared light polarizing plate 51 and the third infrared light polarizing plate 53 may be arranged in such a way that the polarization directions are substantially orthogonal to each other.

The circularly polarizing plate is a combination of a linearly polarizing member and a λ/4 polarizing plate. For example, infrared light that has passed through the second infrared light polarizing plate 52 is reflected by the glasses GL1 in FIG. 3 and subsequently removed by the linearly polarizing member of the first infrared light polarizing plate 51 that has a polarization direction substantially orthogonal to the polarization direction of the second infrared light polarizing plate 52. Among infrared light reflected by an object different from the glasses GL1 without polarization, a circular polarization component passes through the first infrared light polarizing plate 51. Since circularly polarized infrared light is little influenced by the liquid crystal layer 33 when passing through the liquid crystal panel 30, the circularly polarized infrared light does not depend on a driving state of the liquid crystal layer 33. The third infrared light polarizing plate 53 removes influence of diffraction and blurring of the infrared light having passed through the liquid crystal layer 33. Therefore, the infrared camera 11 can generate a suitable camera image without being influenced by the state of infrared light in the liquid crystal layer 33 of the liquid crystal panel 30.

Note that in FIG. 18, the arrangements of the first infrared light polarizing plate 51 and the second visible light polarizing plate 36 or the arrangements of the third infrared light polarizing plate 53 and the first visible light polarizing plate 35 may be exchanged. As described above, the first infrared light polarizing plate 51 that polarizes infrared light in the first rotational direction may be arranged on a first surface of the liquid crystal panel 30, and the third infrared light polarizing plate 53 that polarizes infrared light in the first rotational direction or in a second rotational direction that is different from the first rotational direction may be arranged on a second surface of the liquid crystal panel 30 that is different from the first surface.

In addition, to the lighting unit 20 of the display device 10, for example, one of a light emitting structure using a light emitting element, a light refracting structure using a prism structure, a light reflecting structure using a mirror structure, a light converging structure using a lens, and a light diffusing structure using a diffusing element, a combination of all or some of the foregoing, or any other structure capable of providing visible light that is different from the foregoing may be applied. In this case, the structure that provides visible light emitted from the first area of the light emitting surface of the lighting unit 20 of the display device 10, the first area serving as an area corresponding to a range where the infrared camera 11 is not installed, is only required to serve as an example of a first lighting. In contrast, the structure that provides visible light emitted from the second area that is at least in part different from the first area of the light emitting surface of the lighting unit 20 of the display device 10, such as the second light guide plate 14-2 illustrated in, for example, FIG. 15, is only required to serve as an example of a second lighting.

In the display device 10, the liquid crystal panel 30 may include a plurality of liquid crystal display panels. In this case, at least one liquid crystal display panel may have a light blocking pattern that has light blocking properties. The light blocking pattern is repeatedly arranged. The light blocking pattern includes a first light blocking pattern that is made using a plurality of scan wirings and a second light blocking pattern that is made using a plurality of signal wirings. The plurality of scan wirings serving as the first light blocking pattern is only required to individually extend along the X-axis direction and be arranged separated from each other in the Y-axis direction. A pair of scan wirings extend in the X-axis direction and constitute a first light blocking pattern having light blocking properties. The first light blocking pattern is repeatedly arranged in the Y-axis direction. The light blocking properties mean blocking at least a portion of visible light incident from the lighting unit 20 of the display device 10. The X-axis direction corresponds to a predetermined direction in the first light blocking pattern. The plurality of signal wirings serving as the second light blocking pattern is only required to individually extend along the Y-axis direction and be arranged separated from each other in the X-axis direction. A pair of signal wirings extend in the Y-axis direction and shape a second light blocking pattern having light blocking properties. The second light blocking pattern is repeatedly arranged in the X-axis direction. The Y-axis direction corresponds to a predetermined direction in the second light blocking pattern.

In this case, one scan wiring of a pair of adjacent scan wirings is a first light blocking line. The first light blocking line includes a first inclined section, a second inclined section, and a first flat section. The first inclined section is inclined at an acute angle in a counterclockwise direction with respect to the +X-direction. The second inclined section is inclined at an acute angle in an opposite direction to the first inclined section, that is, a clockwise direction, with respect to the +X-direction. The first flat section extends parallel to the X-axis direction. The first flat section connects to the first inclined section and the second inclined section. The other scan wiring of the pair of adjacent scan wirings is a second light blocking line. The second light blocking line includes a third inclined section, a fourth inclined section, and a second flat section. The second light blocking line is line-symmetric to the first light blocking line with respect to the X-axis direction. The third inclined section is opposed to the first inclined section of the first light blocking line and inclined at an acute angle in the clockwise direction with respect to the +X-direction. The fourth inclined section is opposed to the second inclined section of the first light blocking line and inclined at an acute angle in an opposite direction to the third inclined section, that is, the counterclockwise direction, with respect to the +X-direction. The second flat section extends parallel to the X-axis direction. The second flat section is opposed to the first flat section of the first light blocking line. The second flat section connects to the third inclined section and the fourth inclined section. The third light blocking line that is one signal wiring of a pair of adjacent signal wirings may include a fifth inclined section and a sixth inclined section. The fourth light blocking line that is the other signal wiring of the pair of adjacent signal wirings may include a seventh inclined section and an eighth inclined section.

The infrared light source 21 may be, instead of an infrared light source provided in the non-display area 10B of the display device 10 illustrated in FIG. 1, any one of an infrared light source provided at an arbitrary position, two infrared light sources provided at arbitrary positions, and two or more infrared light sources provided at arbitrary positions matching the display area 10A or the non-display area 10B. The position and size of the second infrared light polarizing plate 52 are only required to be determinable to be able to adjust the polarization direction of infrared light in accordance with the position of each infrared light source 21.

The display device 10 of the present disclosure is only required to be applicable to, representatively, a liquid crystal display meter of a vehicle. Alternatively, the display device 10 may be applied to a display device that an airplane, a train, a machine tool, or any other machine involving operation manipulation includes. Without being limited to a machine involving operation manipulation, the display device 10 may be applied to an arbitrary electronic terminal requiring display of an image and monitoring of an operator.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A display device, comprising:
a display panel;
an infrared camera that is arranged on a rear surface side, the rear surface side being an opposite side to a display surface of the display panel;
an infrared light source that outputs infrared light;
a first imaging polarizing plate that is arranged at a first position matching a main surface side of the display panel and that has a first polarization characteristic for infrared light; and
a second imaging polarizing plate that is arranged at a second position on an output side of the infrared light source and that has a second polarization characteristic, the second polarization characteristic being different from the first polarization characteristic, for infrared light.

2. The display device according to claim 1, wherein the first imaging polarizing plate is arranged at the first position within a range from a rear surface of the display panel to the infrared camera.

3. The display device according to claim 1, wherein the first imaging polarizing plate is arranged on a display surface of the display panel.

4. The display device according to claim 1, wherein
the first imaging polarizing plate polarizes infrared light in a first direction,
the second imaging polarizing plate polarizes infrared light in a second direction that is different from the first direction, and
the first imaging polarizing plate removes infrared light that has a polarization direction in the second direction.

5. The display device according to claim 1, comprising
a third imaging polarizing plate that is arranged on a second surface that is different from a first surface of the display panel,
wherein the first imaging polarizing plate is arranged on the first surface of the display panel,
the first imaging polarizing plate polarizes infrared light in a first rotational direction,
the second imaging polarizing plate polarizes infrared light in a second rotational direction that is different from the first rotational direction, and
the third imaging polarizing plate polarizes infrared light in the first rotational direction or the second rotational direction.

6. The display device according to claim 1, wherein the first imaging polarizing plate and the second imaging polarizing plate have transmission axes set to be substantially orthogonal to each other.

7. The display device according to claim 1, comprising
a backlight that supplies the display panel with visible light,
wherein the first imaging polarizing plate is arranged on a rear surface of the display panel on a light emitting surface side of the backlight as the first position.

8. The display device according to claim 1, wherein the first imaging polarizing plate is arranged at a position matching a field of view (FOV) of the infrared camera and has a size matching the field of view (FOV) of the infrared camera.

9. The display device according to claim 1, wherein the first imaging polarizing plate has a substantially same size as a rear surface of the display panel.

10. The display device according to claim 1, comprising
a cover glass that covers the display panel,
wherein the infrared light source and the second imaging polarizing plate are arranged at a specific position on a rear surface side of the cover glass, and
the cover glass has infrared transmitting paint applied in accordance with the specific position.

11. The display device according to claim 1, wherein
the display panel is a liquid crystal display panel in which the first imaging polarizing plate is arranged between a polarization control sheet and a thin film transistor substrate, in place of a display polarizing plate on a rear surface side, and
the polarization control sheet and the first imaging polarizing plate have transmission axes set to be substantially parallel to each other.

12. The display device according to claim 1, wherein
the infrared camera and the first imaging polarizing plate are arranged in accordance with a display area, and
the infrared light source and the second imaging polarizing plate are arranged in accordance with a non-display area.

13. The display device according to claim 1, wherein
the infrared camera and the first imaging polarizing plate are arranged in a first range matching a display area, and
the infrared light source and the second imaging polarizing plate are arranged in a second range, the second range being different from the first range matching a display area, on the rear surface side of the display panel.

14. The display device according to claim 1, comprising
a backlight that emits visible light to be used for display by the display panel,
wherein the backlight includes a light guide plate configured using a low birefringence material, and
the first imaging polarizing plate is arranged on a rear surface side of the light guide plate.
